(19) United States
(12) Patent Application Publication
(10) Pub. No.: US 2005/0058276 A1
(43) Pub. Date: Mar. 17, 2005

(54) Communication terminal having function of monitoring psychology condition of talkers and operating method thereof

(75) Inventor: Dong Sik Oh, Bucheon-Si (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Curitel Communications, Inc.

(21) Appl. No.: 10/940,148

(22) Filed: Sep. 14, 2004

(30) Foreign Application Priority Data
Sep. 15, 2003 (KR) 10-2003-0063594

(51) Int. Cl. H04M 1/00; H04M 9/00

(52) U.S. Cl. 379/387.01

(57) ABSTRACT

Disclosed are a communication terminal having a function of monitoring psychology condition of talkers an operating method thereof, being adapted to easily check the psychology condition in telephone conversation with the terminal. The invention comprises an amplifying section for amplifying audio data inputted from a microphone or audio data to be outputted to a speaker; a filtering section for eliminating noise of the audio data amplified in the amplifying section; a memory section for storing the audio data having passed the filtering section; a displaying section for displaying the psychology condition of the talkers corresponding to the audio data stored in the memory section; and a comparing control section for controlling the displaying section by measuring amount and intensity of the audio data stored in the memory section per a predetermined time unit.

### BACKGROUND OF THE INVENTION

1. Field of the Invention

The present invention relates to a communication terminal having a function of monitoring psychology condition of talkers and an operating method thereof, and more particularly to a communication terminal having a function of monitoring psychology condition of talkers and an operating method thereof, being adapted to easily check the psychology condition in voice communication with the terminal.

2. Description of the Related Art

Generally, a lie detector is adapted to determine whether a statement of a person to be tested is true or not by making polygraphs of heartbeat, pulse and respiration rate, etc. and comparing them with preset general criteria.

Such a lie detector can simply determine whether the statement of the person to be tested is true or not rather than easily check psychology condition of the person to be tested. The lie detector has the problems that the preset general criteria are vague, data errors are different according to test environments and discrepancies of test result are present according to individuals. Accordingly, it is difficult to correctly test and thus an expensive apparatus should be used to solve the problems.

### SUMMARY OF THE INVENTION

Accordingly, the present invention has been made to solve the above-mentioned problems. The object of the present invention is to provide a communication terminal and an operating method thereof, being adapted to easily check the psychology condition of talkers (i.e., a calling party and a called party) in voice communication with a communication terminal such as a wire/wireless telephone, a cellular phone and a PDA etc.

The other object of the invention is that a function of monitoring the psychology condition of the calling party or the called party in voice communication with the communication terminal is added to the terminal for making the calling party or called party perceive his/her psychology condition, thereby allowing him/her to more quickly check a dialogue skill or a situation in telephone conversation and thus take active measures suited to the situation with a correct judgment.

According to one aspect of the present invention, there is provided a communication terminal having a function of monitoring psychology condition of talkers. The communication terminal comprises an amplifying section for amplifying audio data inputted from a microphone or audio data to be outputted to a speaker; a filtering section for eliminating noise of the audio data amplified by the amplifying section; a memory section for storing the audio data having passed the filtering section; a displaying section for displaying the psychology condition of the talkers corresponding to the audio data stored in the memory section; and a comparing control section for controlling the displaying section by measuring amount and intensity of the audio data stored in the memory section per a predetermined time unit.

Preferably, the comparing control section measures the amount of the audio data stored in the memory section per the predetermined time unit and simultaneously the intensity of the audio data stored in the memory section, compares standard values based on the amount and intensity measured during a predetermined period or preset general standard values with values currently measured and then controls the displaying section depending on a result of the comparison.

In addition, the standard values may be separately set according to each of the talkers. In this case, the comparing control section may separately read the standard values corresponding to each talker, compare the read standard values with the values currently measured and then control the displaying section depending on the result of the comparison.

The displaying section may use a LED (Light Emitting Diode) or a LCD (Liquid Crystal Display) to visually display the psychology condition of the talkers. Also, the displaying section may represent the psychology condition of the talkers with an alarm sound.

According to another aspect of the present invention, there is provided an operating method of a communication terminal having a function of monitoring psychology condition of talkers. The operating method comprises steps of measuring amount and intensity of audio data to be inputted from a microphone or outputted to a speaker in the communication terminal; and comparing the measured amount and intensity with standard values for perceiving the psychology condition of the talker, thereby displaying the psychology condition of the talkers according to the result of the comparison.

Preferably, the step of displaying the psychology condition comprises steps of separating the audio data inputted from the microphone and the audio data to be outputted to the speaker, converting the respective separated data into digital data, amplifying and filtering the digital data and then storing the amplified and filtered digital data in a memory; measuring amount and intensity of the data stored in the memory during a predetermined period, obtaining mean values thereof and then defining the standard values; and comparing the currently measured amount and intensity with the standard values and separately displaying the psychology condition of a calling party or called party, according to the result of the comparison.

Alternatively, the step of displaying the psychology condition comprises steps of separating the audio data inputted from the microphone and the audio data to be outputted to the speaker according to each talker, converting the respective separated data into digital data, amplifying and filtering the digital data and then storing the amplified and filtered digital data in a memory; measuring amount and intensity of the data stored in the memory during a predetermined period according to each talker, obtaining respective mean values thereof and then defining the standard values; and reading the standard values corresponding to each talker, comparing the read standard values with the currently measured amount and intensity and then displaying the psychology condition of the talker according to the result of the comparison.

Further alternatively, the step of displaying the psychology condition comprises steps of comparing the measured amount and intensity with preset general standard values; and separately displaying the psychology condition of a calling party or called party according to the result of the comparison.

According to a preferred embodiment of the present invention, the step of displaying the psychology condition comprises displaying a state of peace mind when the measured amount and intensity are equal to the standard values, a state of intension when the measured amount and intensity are larger than the standard values by a first reference value or more, and an excited state when the measured amount and intensity are greater than the standard values by a second reference value or more.

The present invention is not to determine whether a statement of persons to be tested is true or not but to add a function of monitoring the psychology condition of the calling party or called party to the communication terminal for the purpose of making the calling party or called party perceive his/her psychology condition, thereby allowing him/her to more quickly check a dialogue skill or a situation in telephone conversation and thus take active measures suited to the situation with a correct judgment.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a structure of a communication terminal having a function of monitoring psychology condition of talkers according to a preferred embodiment of the present invention;

FIG. 2 is a flow chart showing an operating method of a communication terminal having a function of monitoring psychology condition of talkers according to a preferred embodiment of the present invention.

### DETAILED DESCRIPTION OF THE PREFERRED EMBODIMENTS

The present invention will now be described more fully with reference to the accompanying drawings. This invention may, however, be embodied in many different forms and should not be construed as being limited to the embodiments set forth herein. Rather, these embodiments are provided so that this disclosure will be thorough and complete and will fully convey the concept of the invention to those skilled on the art.

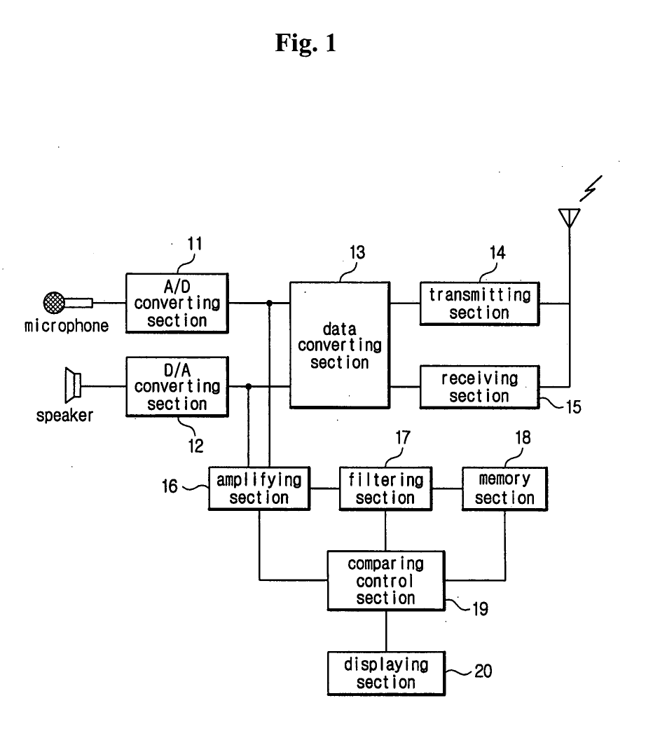

As shown in FIG. 1, a communication terminal having a function of monitoring psychology condition of talkers according to an embodiment of the invention comprises an A/D (analog-to-digital) converting section 11, a D/A (digital-to-analog) converting section 12, a data converting section 13, a transmitting section 14, a receiving section 15, an amplifying section 16, a filtering section 17, a memory section 18, a comparing control section 19 and a displaying section 20.

The A/D converting section 11 converts an analog audio signal provided from a microphone of the communication terminal into a digital signal and transfers the converted signal to the data converting section 13.

The D/A converting section 12 converts a digital signal provided from the data converting section 13 into an analog audio signal and outputs the converted signal via a speaker of the communication terminal.

The data converting section 13 converts the digital signal provided from the A/D converting section 11 into transmit data, which is to be transmitted via the transmitting section 14, and transfers the transmit data to the transmitting section 14. Also, the data converting section 13 converts received data provided from the receiving section 15 into a digital signal, and transfers the converted signal to the D/A converting section 12.

The transmitting section 14 transmits the transmit data provided from the data converting section 13 to a partner.

The receiving section 15 transfers received data provided from the partner to the data converting section 13.

The amplifying section 16 amplifies the digital signal (i.e., digital audio data to be transmitted) provided from the A/D converting section 11 or the digital signal (i.e., received digital audio data) provided from the data converting section 13 and applies the amplified signal to the filtering section 17.

The filtering section 17 performs a filtering operation of eliminating noise of the digital audio data amplified by the amplifying section 16 and then transfer the filtered digital audio data into the memory section 18.

The memory section 18 stores the digital audio data applied from the filtering section 17 and performs operations of reading and deleting the stored digital audio data according to a control of the comparing control section 19.

The comparing control section 19 measures amount of the digital audio data which is stored in the memory section 18 per a predetermined time unit (for example, second) for analyzing speech speed or respiration rate of talkers. Simultaneously, the comparing control section 19 measures intensity of the digital audio data which is stored in the memory section 18 for analyzing voice intonation or wobble of talkers. After the section 19 calculates mean values of the amount and the intensity measured during a predetermined time (for example, 20˜30 seconds) and then compares standard values which are obtained based on the mean values with the amount and intensity currently measured, it controls the displaying section 20 depending on the result of the comparison.

Alternatively, the comparing control section 19 may compare predetermined general criteria (i.e., preset general standard values) as in a lie detector with the amount and intensity currently measured.

The displaying section 20 displays psychology condition (i.e., a peace of mind, a state of tension, an excited state, etc.) of talkers according to the control of the comparing control section 19.

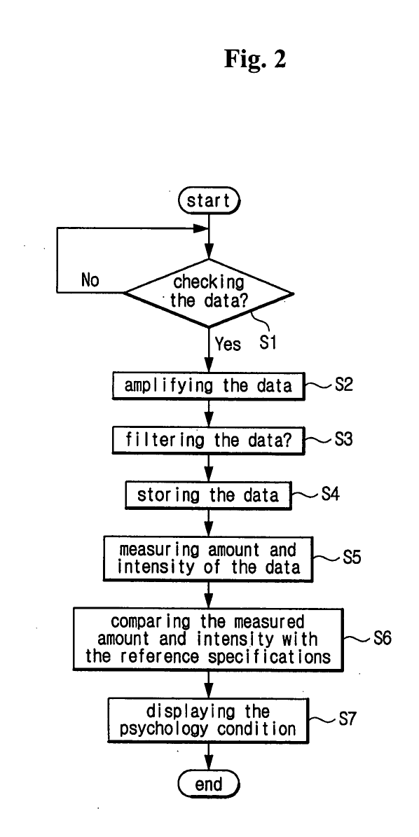

An operating method of a communication terminal having a function of monitoring psychology condition of talkers according to an embodiment of the invention is described with the reference to FIG. 2, as follows.

First, when an audio signal is transmitted to a partner (i.e., a called party) by the communication terminal, the A/D converting section 11 converts an analog audio signal provided from a microphone of the communication terminal into a digital signal and transfers the converted signal to the data converting section 13.

The data converting section 13 converts the digital signal provided from the A/D converting section 11 into transmit data and transfers the transmit data to the partner via the transmitting section 14.

Secondly, when an audio signal is received from a partner (i.e., a calling party) by the communication terminal, the receiving section 15 receives data provided from the partner and transfers the received data to the data converting section 13.

The data converting section 13 converts the received data provided through the receiving section 15 into a digital signal and transfers the converted digital signal to the D/A converting section 12. The D/A converting section 12 then converts the digital signal applied from the data converting section 13 into an analog audio signal and outputs the converted analog audio signal via the speaker of the communication terminal.

At this time, the comparing control section 19 performs control operations for analyzing the psychology condition of talkers, i.e., a calling party and a called party. That is, the section 19 performs two control operations: one operation for signifying the psychology condition of the calling party and the other operation for signifying the psychology condition of the called party.

The calling party may not perceive his/her psychology change in telephone conversation and thus make a mistake when talking with the partner. Accordingly, in order to prevent the mistake from occurring, the comparing control section 19 helps the calling party to realize his/her psychology condition. Meanwhile, the function of signifying the psychology condition of the called party is provided for the calling party to check the psychology condition of the partner and to actively cope with it.

Since the comparing control section 19 must be able to monitor the psychology condition of the calling party as well as the psychology condition of the called party, it should separately perform the data processing of transmission sounds and receipt sounds.

For this purpose, the comparing control section 19 checks whether or not the digital audio data to be transmitted or received is in a signal line between the A/D converting section 11 and the data converting section 13 or a signal line between the data converting section 13 and the D/A converting section 12. At this time, the comparing control section 19 confirms whether the digital audio data applied to the amplifying section 16 is a digital signal applied from the A/D converting section 11 via the amplifying section 16, i.e., a digital audio data to be transmitted by the calling party, or a digital signal applied from the data converting section 13, i.e., a digital audio data received from the called party, for the purpose of separately processing them (step S1).

The amplifying section 16 amplifies the digital audio data to be transmitted by the calling party or the digital audio data received from the called party according to the control of the comparing control section 19 and applies the amplified data to the filtering section 17 (step S2).

Then, the filtering section 17 performs a filtering operation of eliminating noise of the digital audio data amplified by the amplifying section 16 according to the control of the comparing control section 19 (step S3). Thereafter, separated into calling party-relating data and called party-relating data, the filtered digital audio data is stored into the memory section 18 (step S4). In this case, the digital audio data stored in the memory section 18 is temporarily stored to measure amount and intensity of data later. When next new data is stored, the previously stored data is automatically deleted in order of storage and the new data is simultaneously stored.

Then, the comparing control section 19 measures amount of the digital audio data which is stored in the memory section 18 per a predetermined time unit (for example, second) for analyzing speech speed or respiration rate of talkers (i.e., the calling party and the called party). Simultaneously, the comparing control section 19 measures intensity of the digital audio data which is stored in the memory section 18 for analyzing voice intonation or wobble of talkers.

In other words, during a predetermined time (for example, 20˜30 seconds), the comparing control section 19 measures amount of the digital audio data which is stored in the memory section 18 per predetermined time unit (for example, second) and simultaneously intensity of the digital audio data which is stored in the memory section 18. And then, the comparing control section 19 defines reference specifications (i.e., standard values) based on the mean values of the measured amount and intensity of the data.

After the comparing control section 19 defines the standard value as described above, it performs the steps S1˜S4 again. And then, during a predetermined time (for example, 5˜10 seconds), it measures amount of the digital audio data which is stored in the memory section 18 per predetermined time unit (for example, second) and simultaneously intensity of the digital audio data which is stored in the memory section 18 (step S5). Then, the comparing control section 19 compares the measured amount and intensity of the data with the above standard values. That is, it compares the measured result values with the standard values (step S6).

Thereafter, the comparing control section 19 controls the displaying section 20 according to a result of the comparison in the step of S6, and the displaying section 20 displays the psychology condition (i.e., a peace of mind, a state of tension, an excited state, etc.) of talkers according to the control of the comparing control section 19. The comparing control section 19 makes the displaying section separately display the psychology condition of the calling party and the called party (or sender and receiver) (step S7).

For example, blue, yellow and red LEDs in the displaying section 20 may be used to display the psychology condition of talkers. As a result of the comparison, when the measured amount and intensity of the data are similar to the standard values, the blue LED is turned on to indicate a state of peace mind. When the measured amount and intensity of the data are larger than the standard values by a first reference value or more, the yellow LED is turned on to indicate a state of tension. When the measured amount and intensity of the data are greater than the standard values by a second reference value or more, the red LED is turned on to indicate an excited state.

Alternatively, considering a situation that the colors of the LED cannot be distinguished, an alarm sound may be generated. The alarm sound may be intermittently generated in the receipt sound to the extent of not disturbing the telephone conversation.

In addition, a LCD may be used to display a picture or characters indicating the psychology condition of the talkers.

Meanwhile, the comparison operation in the step of S6 may be differently embodied. For example, the comparison may be performed with reference data based on general reference specifications. Alternatively, the comparison may be performed with measured data which are previously stored separately according to each talker.

In the former example, before performing the above-mentioned operation, the comparing control section 19 presets reference data (i.e., general standard values) based on general reference specifications as used in a lie detector and stores them in the memory section 18.

And then, after the comparing control section 19 measures amount of the digital audio data which is stored in the memory section 18 per a predetermined time unit (for example, second) for analyzing speech speed or respiration rate of talkers (i.e., the calling party and the called party) and simultaneously intensity of the digital audio data which is stored in the memory section 18 for analyzing voice intonation or wobble of talkers, it reads the preset and stored general standard values and compares the preset general standard values with the measured amount and intensity of the data (i.e., measured result values).

In the latter example, according to each talker, the comparing control section 19 measures amount of the digital audio data which is stored in the memory section 18 per a predetermined time unit (for example, second) and simultaneously intensity of the digital audio data which is stored in the memory section 18 as mentioned above. Then it defines means values of the measured amount and intensity of the data as standard values and stores them in the memory section 18, according to each talker. That is, the comparison control section 19 secures mean values of each talker, previously to the comparison operation.

Thereafter, the comparing control section 19 measures amount of the digital audio data which is stored in the memory section 18 per a predetermined time unit (for example, second) for analyzing speech speed or respiration rate of talkers (i.e., the calling party and the called party) and simultaneously intensity of the digital audio data which is stored in the memory section 18 for analyzing voice intonation or wobble of talkers. Then the comparing control section 19 reads the standard values corresponding to the talker from the memory section 18 and compares the read standard values with the measured amount and intensity of the data (i.e., measured result values).

As explained above, a communication terminal according to the invention is provided with a function of monitoring the psychology condition of talkers in telephone conversation. Accordingly, the psychology condition of the talkers can be perceived to them, so that they can more quickly check a dialogue skill or a situation in telephone conversation and thus take active measures suited to it with a correct judgment.

While the invention has been shown and described with reference to certain preferred embodiments thereof, it will be understood by those skilled in the art that various changes in form and details may be made therein without departing from the spirit and scope of the invention as defined by the appended claims.

1. A communication terminal having a function of monitoring psychology condition of talkers comprising,
an amplifying section for amplifying audio data inputted from a microphone or audio data to be outputted to a speaker;
a filtering section for eliminating noise of the audio data amplified by the amplifying section;
a memory section for storing the audio data having passed the filtering section;
a displaying section for displaying the psychology condition of the talkers corresponding to the audio data stored in the memory section; and
a comparing control section for controlling the displaying section by measuring amount and intensity of the audio data stored in the memory section per a predetermined time unit.

2. The communication terminal according to claim 1, wherein the comparing control section measures the amount of the audio data stored in the memory section per the predetermined time unit and simultaneously the intensity of the audio data stored in the memory section, compares standard values based on the amount and the intensity measured during a predetermined period or preset general standard values with currently measured values and then controls the displaying section depending on a result of the comparison.

3. The communication terminal according to claim 2, wherein the standard values are separately defined according to each of the talkers, and the comparing control section separately reads the standard values corresponding to each talker, compares the read standard values with the currently measured values and then controls the displaying section according to a result of the comparison.

4. The communication terminal according to claim 1, wherein the displaying section visually displays the psychology condition of the talkers.

5. The communication terminal according to claim 4, wherein the displaying section uses a LED or a LCD.

6. The communication terminal according to claim 1, wherein the displaying section represents the psychology condition of the talkers with an alarm sound.

7. An operating method of a communication terminal having a function of monitoring psychology condition of talkers comprising steps of,
measuring amount and intensity of audio data to be inputted from a microphone or outputted to a speaker in the communication terminal;
comparing the measured amount and intensity with standard values for perceiving the psychology condition of the talkers; and
displaying the psychology condition of the talkers according to the

8. The operating method according to claim 7, wherein the step of displaying the psychology condition comprises steps of,
separating the audio data inputted from the microphone and the audio data to be outputted to the speaker, converting the respective separated data into digital data, amplifying and filtering the digital data and then storing the amplified and filtered digital data in a memory;
measuring amount and intensity of the data stored in the memory during a predetermined period, obtaining mean values thereof and then defining the standard values; and
comparing the currently measured amount and intensity with the standard values and separately displaying the psychology condition of a calling party or called party, according to a result of the comparison.

9. The operating method according to claim 7, wherein the step of displaying the psychology condition comprises steps of,
separating the audio data inputted from the microphone and the audio data to be outputted to the speaker according to each talker, converting the respective separated data into digital data, amplifying and filtering the digital data and then storing the amplified and filtered digital data in a memory;
measuring amount and intensity of the data stored in the memory during a predetermined period according to each talker, obtaining respective mean values thereof and then defining the standard values; and
reading the standard values corresponding to each talker, comparing the read standard values with the currently measured amount and intensity and then displaying the psychology condition of the talkers depending on a result of the comparison.

10. The operating method according to claim 7, wherein the step of displaying the psychology condition comprises steps of,
comparing the measured amount and intensity with preset general standard values; and
separately displaying the psychology condition of a calling party or called party according to the result of the comparison.

11. The operating method according to claim 7, wherein the step of displaying the psychology condition comprises displaying a state of peace mind when the measured amount and intensity are equal to the standard values, a state of intension when the measured amount and intensity are larger than the standard values by a first reference value or more, and an excited state when the measured amount and intensity are greater than the standard values by a second reference value or more.

12. The operating method according to claim 7, wherein the psychology condition of the talkers is visually displayed.

13. The operating method according to claim 7, wherein the psychology condition of the talkers is represented by an alarm sound.
